(19) United States
(12) Patent Application Publication
(10) Pub. No.: US 2012/0252914 A1
(43) Pub. Date: Oct. 4, 2012

(54) FLAME-PROTECTED POLYMER FOAMS

(75) Inventors: Klaus Hahn, Kirchheim (DE); Olaf Kriha, Neustadt (DE); Ingo Bellin, Mannheim (DE); Frank Braun, Ludwigshafen (DE); Patrick Spies, Neustadt (DE); Jan Kurt Walter Sandler, Heidelberg (DE); Geert Janssens, Friedelsheim (DE); Jürgen Fischer, Limburgerhof (DE); Christoph Fleckenstein, Freigericht (DE); Hartmut Denecke, Ludwigshafen (DE); Sabine Fuchs, Mannheim (DE); Peter Merkel, Zellertal (DE); Manfred Pawlowski, Singapore (SG); Holger Ruckdäschel, St. Martin (DE); Klemens Massonne, Bad Durkheim (DE)

(73) Assignee: BASF SE, Ludwigshafen (DE)

(21) Appl. No.: 13/515,962

(22) PCT Filed: Dec. 13, 2010
(86) PCT No.: PCT/EP2010/069528

§ 371 Date: Jun. 14, 2012

(30) Foreign Application Priority Data
Dec. 18, 2009 (DE) 102009059781.6

(51) Int. Cl. C08L 25/18; C08K 3/04; C08J 9/14; B29B 9/02; C08J 9/228

(52) U.S. Cl. 521/81; 264/141; 521/139; 521/82

(57) ABSTRACT

Flame-retardant polymer foams which comprise, as flame retardant, at least one halogenated polymer, for example brominated polystyrene or styrene-butadiene block copolymer having bromine content in the range from 40 to 80% by weight, or tetrabromobisphenol A compounds (TBBPA), processes for producing these, and also flame-retardant expandable styrene polymers.

The invention relates to flame-retardant polymer foams which comprise, as flame retardant, at least one halogenated polymer, processes for producing these, and also flame-retardant expandable styrene polymers.

The provision of flame retardants to polymer foams is important for a wide variety of applications, an example being molded polystyrene foams made of expandable polystyrene (EPS) or extruded polystyrene foam sheets (XPS) for insulating buildings. The compounds used hitherto for homo- and copolystyrenes here are mainly halogen-containing, in particular brominated, organic compounds. However, many of these low-molecular-weight brominated substances, and in particular hexabromocyclododecane (HBCD), are the subject of discussion about damage that they may cause to the environment and to health.

The amounts of halogen-free flame retardants that have to be used in order to achieve the same flame-retardant effect as halogen-containing flame retardants is generally markedly higher. It is therefore frequently the case that halogen-containing flame retardants that can be used with thermoplastic polymers, such as polystyrene, cannot be used with polymer foams, because they either disrupt the foaming process or affect the mechanical and thermal properties of the polymer foam. The large amounts of flame retardant can moreover reduce the stability of the suspension when expandable polystyrene is produced via suspension polymerization.

WO 2007/058736 describes thermally stable, brominated butadiene-styrene copolymers as alternative flame retardant to hexabromocyclododecane (HBCD) in styrene polymers and extruded polystyrene foam sheets (XPS).

JP-A 2007-238926 describes thermoplastic foams with high heat resistance which have been provided with brominated flame retardants to give stable flame retardancy, where the weight loss from these in thermogravimetic analysis is 5% at temperatures above 270° C.

Because of variations in fire behavior and variations in fire tests, it is often impossible to predict how the flame retardants used with thermoplastic polymers will behave in polymer foams.

It was therefore an object of the invention to provide a flame retardant for polymer foams, in particular for expandable polystyrene (EPS) or extruded polystyrene foam sheets (XPS), which does not have any substantial effect on the foaming process or on mechanical properties, and which is not hazardous to the environment or to health, and which, in particular when used in small amounts, can give adequate flame retardancy in polymer foams. The flame retardant should have high thermal stability for incorporation in extrusion processes, and, respectively, should exhibit little effect on regulators and initiators in the suspension polymerization process.

Accordingly, the flame-retardant polymer foams mentioned in the introduction have been found.

Preferred embodiments are given in the subclaims.

The average molecular weight, determined by means of gel permeation chromatography (GPC), of the halogenated polymer used as flame retardant is preferably in the range from 5000 to 300,000, in particular from 30,000 to 150,000.

The weight loss from the halogenated polymer in thermogravimetric analysis (TGA) is 5% by weight at a temperature of 250° C. or higher, preferably in the range from 270 to 370° C.

The bromine content of preferred halogenated polymers is in the range from 0 to 80 percent by weight, preferably from 10 to 75 percent by weight, and the chlorine content thereof is in the range from 0 to 50 percent by weight, preferably from 1 to 25 percent by weight, based on the halogenated polymer.

Halogenated polymers preferred as flame retardant are brominated polystyrene or styrene-butadiene block copolymer having bromine content in the range from 40 to 80% by weight.

Other halogenated polymers preferred as flame retardant are polymers having tetrabromobisphenol A units (TBBPA), for example tetrabromobisphenol A diglycidyl ether compounds (CAS number 68928-70-1 or 135229-48-0).

The flame-retardant polymer foams of the invention generally comprise, based on the polymer foam, an amount in the range from 0.2 to 25% by weight, preferably in the range from 1 to 15% by weight, of the halogenated polymers. Amounts of from 5 to 10% by weight, based on the polymer foam, ensure adequate flame retardancy, in particular for foams made of expandable polystyrene.

The effectiveness of the halogenated polymers can be still further improved via addition of suitable flame retardant synergists, examples being the thermal free-radical generators dicumyl peroxide, di-tert-butyl peroxide or dicumyl. Zinc compounds or antimony trioxide are suitable flame retardant synergists. In this case, the amounts used of the flame retardant synergist are usually from 0.05 to 5 parts by weight, in addition to the halogenated polymer.

Other flame retardants can also be used, examples being melamine, melamine cyanurates, metal oxides, metal hydroxides, phosphates, phosphinates, or expandable graphite. Suitable additional halogen-free flame retardants are commercially available as Exolit OP 930, Exolit OP 1312, DOPO, HCA-HQ, M-Ester Cyagard RF-1241, Cyagard RF-1243, Fyrol PMP, AIPi, Melapur 200, Melapur MC, APP.

The density of the flame-retardant polymer foams is preferably in the range from 5 to 200 kg/m³, particularly preferably in the range from 10 to 50 kg/m³, and the proportion of closed cells in these foams is preferably more than 80%, particularly preferably from 95 to 100%.

It is preferable that the polymer matrix of the flame-retardant polymer foams is composed of thermoplastic polymers or of a polymer mixture, in particular of styrene polymers.

The flame-retardant, expandable styrene polymers (EPS) and extruded styrene polymer foams (XPS) of the invention can be processed via mixing to incorporate a blowing agent and the halogenated polymer into the polymer melt and subsequent extrusion and pelletization under pressure to give expandable pellets (EPS), or via extrusion and depressurization with use of appropriately shaped dies to give foam sheets (XPS) or foam strands.

Expandable styrene polymers (EPS) are styrene polymers comprising blowing agent. The size of the EPS beads is preferably in the range from 0.2 to 2 mm. Molded styrene polymer foams can be obtained via prefoaming and sintering of the appropriate expandable styrene polymers (EPS). The molded styrene polymer foams preferably have from 2 to 15 cells/mm.

The average molar mass M_{w} of the expandable styrene polymer is preferably in the range from 120,000 to 400,000 g/mol, particularly preferably in the range from 180,000 to 300,000 g/mol, measured by means of gel permeation chromatography with refractiometric detection (RI) against polystyrene standards. The molar mass of the expandable polystyrene in the extrusion processes is generally below the molar mass of the polystyrene used by about 10,000 g/mol, because of the degradation of molar mass caused by shear and/or by heat.

The styrene polymers used preferably comprise glassclear polystyrene (GPPS), impact-resistant polystyrene (HIPS), anionically polymerized polystyrene, or impact-resistant polystyrene (AIPS), styrene-α-methylstyrene copolymers, acrylonitrile-butadiene-styrene polymers (ABS), styrene-acrylonitrile polymer (SAN), acrylonitrile-styrene-acrylate (ASA), styrene acrylates, such as styrene-methyl acrylate (SMA), and styrene-methyl methacrylate (SMMA), methyl methacrylate-butadiene-styrene (MBS), methyl methacrylate-acrylonitrile-butadiene-styrene (MABS) polymers, styrene-N-phenylmaleimide copolymers (SPMI), or a mixture thereof, or a mixture of the above-mentioned styrene polymers with polyolefins, such as polyethylene or polypropylene, and polyphenylene ether (PPE).

The abovementioned styrene polymers can be blended with thermoplastic polymers, such as polyamides (PA), polyolefins, e.g. polypropylene (PP) or polyethylene (PE), polyacrylates, e.g. polymethyl methacrylate (PMMA), polycarbonate (PC), polyesters, e.g. polyethylene terephthalate (PET) or polybutylene terephthalate (PBT), polyether sulfones (PES), polyether ketones, or polyether sulfides (PES), or a mixture thereof, generally in total proportions of up to at most 30% by weight, preferably in the range from 1 to 10% by weight, based on the polymer melt, in order to improve mechanical properties or heat resistance, optionally with use of compatibilizers. Mixtures within the abovementioned ranges of amounts are also possible with, for example, hydrophobically modified or functionalized polymers or oligomers, rubbers, e.g. polyacrylates or polydienes, for example styrene-butadiene block copolymers, or biodegradable aliphatic or aliphatic/aromatic copolyesters.

Examples of suitable compatibilizers are maleic-anhydride-modified styrene copolymers, and organosilanes or polymers containing epoxy groups.

Polymer recyclates derived from the abovementioned thermoplastic polymers, in particular styrene polymers, and expandable styrene polymers (EPS) can also be admixed with the styrene polymers in the production process, the amounts being those that do not significantly impair the properties of the same, generally at most 50% by weight, in particular from 1 to 20% by weight.

For high-temperature-resistant foams, it is preferable to use mixtures made of SMA and SAN and, respectively, SAN and SPMI. The proportion is selected as appropriate for the desired heat resistance. The content of acrylonitrile in SAN is preferably from 25 to 33% by weight. The proportion of methacrylate in SMA is preferably from 25 to 30% by weight.

Particularly preferred flame-retardant polymer foams comprise mixtures made of SAN and SMA as polymer matrix, TBBPA compounds as flame retardants, and antimony trioxide as flame retardant synergist.

The styrene polymer melt comprising blowing agent generally comprises, based on the styrene polymer melt comprising blowing agent, a total proportion of from 2 to 10% by weight, preferably from 3 to 7% by weight, of one or more blowing agents distributed homogeneously. Suitable blowing agents are the physical blowing agents usually used in EPS, e.g. aliphatic hydrocarbons having from 2 to 7 carbon atoms, alcohols, ketones, ethers, or halogenated hydrocarbons. It is preferable to use isobutane, n-butane, isopentane, or n-pentane. For XPS it is preferable to use CO₂ or a mixture with alcohols or with ketones.

To improve foamability, finely distributed droplets of internal water can be introduced into the styrene polymer matrix. This can by way of example be achieved via addition of water to the molten styrene polymer matrix. Addition of the water can take place at a location which is upstream of, identical with, or downstream of the blowing-agent feed. Homogeneous distribution of the water can be achieved by means of dynamic or static mixers. An adequate amount of water is generally from 0 to 2% by weight, preferably from 0.05 to 1.5% by weight, based on the styrene polymer.

When expandable styrene polymers (EPS) which have at least 90% of the internal water in the form of droplets of internal water with diameter in the range from 0.5 to 15 μm are foamed they give foams with an adequate cell number and with homogeneous foam structure.

The amount added of blowing agent and of water is selected in such a way that the expansion capability a of the expandable styrene polymers (EPS), defined as bulk density prior to the foaming process/bulk density after the foaming process, is at most 125, preferably from 25 to 100.

The bulk density of the expandable styrene polymer pellets (EPS) of the invention is generally at most 700 g/l, preferably in the range from 590 to 660 g/l. When fillers are used, bulk densities in the range from 590 to 1200 g/l can occur as a function of the type and amount of the filler.

The styrene polymers can comprise the usual and known auxiliaries and additives, examples being flame retardants, fillers, nucleating agents, UV stabilizers, chain-transfer agents, blowing agents, plasticizers, antioxidants, soluble and insoluble inorganic and/or organic dyes and pigments, e.g. infrared (IR) absorbers, for example carbon black, graphite, or aluminum powder. The amounts added of the dyes and pigments are generally in the range from 0.01 to 30% by weight, preferably in the range from 1 to 5% by weight. In particular in the case of polar pigments it can be advantageous to use a dispersing agent, e.g. organosilanes, polymers containing epoxy groups, or maleic-anhydride-grafted styrene polymers, in order to achieve homogeneous and microdisperse distribution of the pigments within the styrene polymer. Preferred plasticizers are mineral oils and phthalates, the amounts that can be used of these being from 0.05 to 10% by weight, based on the styrene polymer.

The amount of the IR absorbers used depends on their nature and effect. The molded styrene polymer foam preferably comprises from 0.5 to 5% by weight, particularly from 1 to 4% by weight, of IR absorbers. Preferred IR absorbers are graphite, carbon black, or aluminum, with average particle size in the range from 1 to 50 μm.

The average particle size of the graphite preferably used is preferably from 1 to 50 μm, in particular from 2.5 to 12 μm, its bulk density being from 100 to 500 g/l, and its specific surface area being from 5 to 20 m²/g. Natural graphite or ground synthetic graphite can be used. The amounts of the graphite particles comprised within the styrene polymer are preferably from 0.05 to 8% by weight, in particular from 0.1 to 5% by weight.

A problem in the use of graphite particles consists in the high combustibility of the molded polystyrene foams comprising graphite particles. In order to pass the fire tests (B1 and B2 to DIN 4102) required for construction-industry applications, the abovementioned flame retardants are added to the expandable styrene polymers in the invention. Surprisingly, said flame retardants do not cause any kind of impairment of the mechanical properties of the molded polystyrene foams comprising carbon black or comprising graphite.

It is preferable that the thermal conductivity λ, determined at 10° C. to DIN 52612, of the molded styrene polymer foams comprising IR absorbers is below 32 mW/m*K, preferably in the range from 27 to 31 mW/m*K, particularly preferably in the range from 28 to 30 mW/m*K, even for densities in the range from 7 to 20 WI, preferably in the range from 10 to 16 g/l.

The low thermal conductivities are generally achieved even when the blowing agent has in essence diffused out of the cells, i.e. the cells have been filled with a gas which is composed of at least 90% by volume, preferably from 95 to 99% by volume, of an inorganic gas, in particular air.

Various processes can be used to produce the particularly preferred, expandable styrene polymers (EPS).

In one embodiment, the athermanous particles and a nonionic surfactant are mixed with a melt of the styrene polymer, preferably in an extruder. The blowing agent is simultaneously fed into the melt here. It is also possible to incorporate the athermanous particles into a melt of styrene polymer comprising blowing agent, and it is advantageous here to use marginal fractions extracted by sieving from a range of beads from polystyrene beads produced in a suspension polymerization process and comprising blowing agent. The polystyrene melt comprising blowing agent and comprising athermanous particles is extruded and comminuted to give pellets comprising blowing agent. Since the athermanous particles can have strong nucleating effect, the material should be rapidly cooled under pressure after extrusion, in order to avoid foaming. It is therefore advantageous to carry out underwater pelletization in a closed system under pressure.

It is also possible to use a separate step for adding the blowing agent to the styrene polymers comprising athermanous particles. It is then preferable here that the pellets in aqueous suspension are impregnated with the blowing agent.

In all three instances, the finely divided athermanous particles and the nonionic surfactant can be added directly to a polystyrene melt. However, it is also possible to add the athermanous particles in the form of a concentrate in polystyrene, to the melt. However, it is preferable that polystyrene pellets and athermanous particles are added together to an extruder, and that the polystyrene is melted and mixed with the athermanous particles.

In principle, it is also possible to incorporate the athermanous particles and a nonionic surfactant during the suspension polymerization process, as long as they are sufficiently inert toward the water that is generally used as suspension medium. In this process, they can be added to the monomeric styrene prior to suspension, or they can be added to the reaction mixture during the course of, preferably during the first half of, the polymerization cycle. The blowing agent is preferably added during the course of the polymerization process, but it can also be incorporated into the styrene polymer subsequently. A factor that has been found to be advantageous for the stability of the suspension here is that a solution of polystyrene (or, respectively, an appropriate styrene copolymer) in styrene (or, respectively, in the mixture of styrene with comonomers) is present at the start of the suspension polymerization process. It is preferable here to begin from a solution of strength from 0.5 to 30% by weight, in particular from 5 to 20% by weight, of polystyrene in styrene. It is possible here to dissolve virgin polystyrene in monomers, but it is advantageous to use what are known as marginal fractions, where these are excessively large or excessively small beads that are removed by sieving during separation of the range of beads produced during production of expandable polystyrene. The diameters of these unusable marginal fractions are in practice greater than 2.0 mm and, respectively, smaller than 0.2 mm. Polystyrene recyclate and foam polystyrene recyclate can also be used. Another possibility consists in prepolymerization of styrene in bulk as far as a conversion of from 0.5 to 70%, and suspending the prepolymer together with the athermanous particles in the aqueous phase, and polymerizing to completion.

The expandable styrene polymers (EPS) are particularly preferably produced via polymerization of styrene and optionally of copolymerizable monomers in aqueous suspension, and impregnation with a blowing agent, where the polymerization process is carried out in the presence of from 0.1 to 5% by weight of graphite particles, based on the styrene polymer, and of a nonionic surfactant.

Examples of a suitable nonionic surfactant are maleic anhydride copolymers (MA), e.g. made of maleic anhydride and C₂₀₋₂₄-1-olefin, polyisobutylene-succinic anhydrides (PIBSA), or reaction products of these with hydroxypolyethylene glycol ester, or with diethylaminoethanol, or with amines, such as tridecylamine, octylamine, or polyether amine, tetraethylenepentamine, or a mixture thereof. The molar masses of the nonionic surfactant are preferably in the range from 500 to 3000 g/mol. The amounts used thereof are generally in the range from 0.01 to 2% by weight, based on styrene polymer.

The expandable styrene polymers comprising athermanous particles can be processed to give polystyrene foams of densities from 5 to 35 g/l, preferably from 8 to 25 g/l, and in particular from 10 to 15 g/l.

For this, the expandable beads are prefoamed. This is mostly achieved via heating of the beads with steam in what are known as prefoamers.

The resultant prefoamed beads are then fused to give moldings. For this, the prefoamed beads are placed in molds which are not gas-tight when closed, and are treated with steam. The moldings can be removed after cooling.

The foams produced from the expandable styrene polymers of the invention feature excellent thermal insulation. This effect is particularly clearly apparent at low densities.

The possibility of markedly reducing the density of the molded styrene polymer foams for identical thermal conductivity can give savings in material. In comparison with conventional expandable styrene polymers, identical thermal insulation can be achieved with substantially lower bulk densities, and it is therefore possible to use thinner foam sheets with the expandable polystyrene beads produced in the invention, with resultant saving of space.

The foams can be used for the thermal insulation of buildings and of parts of buildings, for the thermal insulation of machinery and of household equipment, and also as packaging materials.

To produce the expandable styrene polymers, the blowing agent can be incorporated by mixing into the polymer melt. One possible process comprises the stages of a) melt production, b) mixing, c) cooling, d) conveying, and e) pelletizing. Each of these stages may be executed by using the apparatus or combinations of apparatus known from plastics processing. Apparatus suitable for the process of incorporation by mixing are static or dynamic mixers, such as extruders. The polymer melt can be taken directly from a polymerization reactor, or can be produced directly in the mixing extruder, or in a separate melting extruder, via melting of polymer pellets. The cooling of the melt may take place in the mixing assemblies or in separate coolers. Examples of pelletizers which may be used are pressurized underwater pelletizers, pelletizers with rotating knives and cooling via spray-misting of temperature-control liquids, or pelletizers involving atomization. Examples of suitable arrangements of apparatus for carrying out the process are:

a) polymerization reactor—static mixer/cooler—pelletizer
b) polymerization reactor—extruder—pelletizer
c) extruder—static mixer—pelletizer
d) extruder—pelletizer.

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. Cooling to the region of the glass transition temperature is not necessary.

The die plate is heated at least to the temperature of the polystyrene melt comprising blowing agent. The temperature of the die plate is preferably above the temperature of the polystyrene melt comprising blowing agent by from 20 to 100° C. This avoids polymer deposits in the dies and ensures problem-free pelletization.

In order to obtain marketable pellet sizes, the diameter (D) of the die holes at the exit from the die should be in the range from 0.2 to 1.5 mm, preferably in the range from 0.3 to 1.2 mm, particularly preferably in the range from 0.3 to 0.8 mm. Even after die swell, this permits controlled setting of pellet sizes below 2 mm, in particular in the range from 0.4 to 1.4 mm.

Particular preference is given to a process for producing flame-retardant, expandable styrene polymers (EPS) comprising the steps of
a) using a static or dynamic mixer at a temperature of at least 150° C. for mixing to incorporate an organic blowing agent and from 1 to 25% by weight of the halogenated polymer used in the invention into the polymer melt,
b) cooling the styrene polymer melt comprising blowing agent to a temperature of from 120° to 200° C.,
c) discharge through a die plate with holes, the diameter of which at the exit from the die is at most 1.5 mm, and
d) pelletizing the melt comprising blowing agent directly downstream of the die plate under water at a pressure in the range from 1 to 20 bar.

It is also possible to use suspension polymerization to produce the expandable styrene polymers (EPS) of the invention.

In the suspension polymerization process, the monomer used preferably comprises styrene alone. However, it is possible that up to 20% of the weight of styrene has been replaced by other ethylenically unsaturated monomers, e.g. alkylstyrenes, divinylbenzene, acrylonitrile, 1,1-diphenyl ether, or α-methylstyrene.

The usual auxiliaries can be added during the suspension polymerization process, examples being peroxide initiators, suspension stabilizers, blowing agents, chain-transfer agents, expansion aids, nucleating agents, and plasticizers. The amounts added of the cyclic or acyclic halogenated polymer of the invention during the polymerization process are from 0.5 to 25% by weight, preferably from 5 to 15% by weight. The amounts added of blowing agents are from 3 to 10% by weight, based on monomer. They can be added to the suspension prior to, during, or after the polymerization process. Suitable blowing agents are aliphatic hydrocarbons having from 4 to 6 carbon atoms. It is advantageous to use inorganic Pickering dispersing agents as suspension stabilizers, an example being magnesium pyrophosphate or calcium phosphate.

The suspension polymerization process produces bead-shaped particles that are in essence round, with an average diameter in the range from 0.2 to 2 mm.

In order to improve processability, the finished expandable styrene polymer pellets can be coated with the usual and known coating agents, examples being metal stearates, glycerol esters, and finely divided silicates, antistatic agents, or anticaking agent.

The EPS pellets can be coated with glycerol monostearate GMS (typically 0.25%), glycerol tristearate (typically 0.25%), finely divided Aerosil R972 silica (typically 0.12%), and Zn stearate (typically 0.15%), and also with antistatic agent.

In a first step, the expandable styrene polymer pellets of the invention can be prefoamed by using hot air or steam to give foam beads of density in the range from 8 to 200 kg/m³, in particular from 10 to 50 kg/m³, and in a 2nd step they can be fused in a closed mold to give molded foams.

The expandable polystyrene beads can be processed to give polystyrene foams of densities from 8 to 200 kg/m³, preferably from 10 to 50 kg/m³. For this, the expandable beads are prefoamed. This is mostly achieved via heating of the beads with steam in what are known as prefoamers. The resultant prefoamed beads are then fused to give moldings. For this, the prefoamed beads are placed in molds which are not gas-tight when closed, and are treated with steam. The moldings can be removed after cooling.

### EXAMPLES

Flame retardants used:
FRT 1 brominated polystyrene having about 66% by weight bromine content and a glass transition temperature of 195° C. (PYRO-CHEK® 68PB from Albemarle Corporation)
FRT 2 brominated styrene-butadiene diblock copolymer (Mw 56,000, styrene block 37%, 1,2-vinyl content 72%, TGA weight loss 5% at 238° C.) produced as in Example 8 of WO 2007/058736
HBCD hexabromocyclododecane (comparison)

Intrinsic viscosities IV (0.5% strength in toluene at 25° C.) were determined to DIN 53 726

The fire behavior of the foam sheets was determined at foam density 15 kg/m³ to DIN 4102.

### Examples 1 to 4 and Comparative examples C1 to C4

A mixture made of 150 parts of demineralized water, 0.1 part of sodium pyrophosphate, 100 parts of styrene, 0.45 part of tert-butyl 2-ethylperoxyhexanoate, 0.2 part of tert-butyl perbenzoate, 5 parts of Kropfmühl UFT 99,5 graphite powder, and also 3 parts of the respective flame retardant stated in the table were heated to 90° C. in a pressure-resistant stirred tank, with stirring. In some of the examples, 0.2 part by weight of dicumyl and, respectively, dicumyl peroxide was also added as flame retardant synergist, together with the flame retardants.

After 2 hours at 90° C., 4 parts of a 10% strength aqueous solution of polyvinylpyrrolidone were added. The mixture was then stirred at 90° C. for a further 2 hours, and 7 parts of a mixture made of 80% of n-pentane and 20% of isopentane were added. The mixture was then stirred at 110° C. for 2 hours and finally at 140° C. for 2 hours.

The resultant expandable polystyrene beads were washed with demineralized water, subjected to sieve extraction with a setting of from 0.7-1.0 mm, and then dried in warm air (30° C.).

The beads were prefoamed by exposure to a current of steam and, after storage for 12 hours, fused via further treatment with steam in a closed mold to give foam slabs of density 15 kg/m³.

Intrinsic viscosities IV (0.5% strength in toluene at 25° C.) were determined to DIN 53 726

The fire behavior of the foam sheets was determined at foam density 15 kg/m³ to DIN 4102.

Table 1 below collates the results:

TABLE 1

| | | | | Fire behavior |
|---|---|---|---|---|
| | Flame retardant | Flame retardant synergist | Intrinsic viscosity | (B2 test to |
| Example | (parts by weight) | (parts by weight) | (IV, ml/g) | DIN 4102) |
| C1 | — | — | 86.5 | failed |
| C2 | — | 0.2 of dicumyl peroxide | 83.1 | failed |
| C3 | 3 parts by weight of | — | 74.2 | passed |
| | HBCD | | | |
| C4 | 3 parts by weight of | 0.2 of dicumyl peroxide | 72.1 | passed |
| | HBCD | | | |
| 1 | 3 parts by weight of | — | 85.5 | passed |
| | FRT 1 | | | |
| 2 | 3 parts by weight of | — | 86.1 | passed |
| | FRT 2 | | | |
| 3 | 3 parts by weight of | 0.2 of dicumyl peroxide | 83.8 | passed |
| | FRT 2 | | | |
| 4 | 3 parts by weight of | 0.2 of dicumyl | 85.5 | passed |
| | FRT 2 | | | |

1-15. (canceled)

16. A flame-retardant polymer foam with a polymer matrix made of thermoplastic polymers or of a polymer mixture, which comprises from 1 to 10 percent by weight of an infrared absorber, based on the polymer foam, and, as flame retardant, at least one halogenated polymer.

17. The flame-retardant polymer foam according to claim 16, wherein the average molecular weight, determined by means of gel permeation chromatography (GPC), of the halogenated polymer is in the range from 5000 to 300,000.

18. The flame-retardant polymer foam according to claim 16, wherein the weight loss of the halogenated polymer in thermogravimetric analysis (TGA) is 5% by weight at a temperature of 250° C. or higher.

19. The flame-retardant polymer foam according to claim 16, wherein the bromine content of the halogenated polymer is in the range from 10 to 80 percent by weight and the chlorine content thereof is in the range from 1 to 25 percent by weight.

20. The flame-retardant polymer foam according to claim 16, wherein the flame retardant used comprises a brominated polystyrene or styrene-butadiene block copolymer having bromine content in the range from 40 to 80% by weight.

21. The flame-retardant polymer foam according to claim 16, which comprises, as flame retardant, a polymer having tetrabromobisphenol A units.

22. The flame-retardant polymer foam according to claim 16, which comprises, based on the polymer foam, an amount in the range from 0.2 to 25% by weight of the halogenated polymer.

23. The flame-retardant polymer foam according to claim 16, which comprises, as flame retardant synergist, antimony trioxide, dicumyl, or dicumyl peroxide.

24. The flame-retardant polymer foam according to claim 16, which comprises, as IR absorber, graphite with an average particle size of from 1 to 50 μm.

25. The flame-retardant polymer foam according to claim 16, which comprises a polymer matrix made of polystyrene, styrene-methyl(meth)acrylate (SMA), styrene-acrylonitrile copolymer (SAN), or styrene-N-phenylmaleimide copolymer (SPMI), or a mixture thereof.

26. A process for producing expandable styrene polymers (EPS) rendered flame-retardant by a halogen-free method, or for producing flame-retardant extruded styrene polymer foams (XPS), which comprises using, as IR absorber, graphite with an average particle size of from 1 to 50 μm, and, as flame retardant, at least one halogenated polymer according to claim 17.

27. A process for producing flame-retardant, expandable styrene polymers (EPS) comprising the steps of
a) using a static or dynamic mixer at a temperature of at least 150° C. for mixing to incorporate an organic blowing agent, graphite with an average particle size of from 1 to 50 μm, and from 1 to 25% by weight of the halogenated polymer according to claim 16 into a styrene polymer melt,
b) cooling the styrene polymer melt comprising blowing agent to a temperature of at least 120° C.,
c) discharging through a die plate with holes, the diameter of which at the exit from the die is at most 1.5 mm, and
d) pelletizing the melt comprising blowing agent directly downstream of the die plate under water at a pressure in the range from 1 to 20 bar.

28. A process for producing flame-retardant, expandable styrene polymers (EPS) via polymerization of styrene in aqueous suspension in the presence of from 0.1 to 5% by weight of graphite particles, of an organic blowing agent and of a flame retardant, which comprises using, as flame retardant, the halogenated polymer according to claim 17.

29. A flame-retardant, expandable styrene polymer (EPS), obtainable according to claim 26.

30. A process for producing flame-retardant molded polystyrene foams, which comprises using hot air or steam in a first step to prefoam the expandable styrene polymer according to claim 29 to give foam beads of density in the range from 8 to 200 g/l, and fusing these in a closed mold in a 2nd step.
